(19) United States
(12) Patent Application Publication
(10) Pub. No.: US 2011/0186033 A1
(43) Pub. Date: Aug. 4, 2011

(54) COOKING STOVE

(75) Inventor: FREDDIE CHANG, Arcadia, CA (US)

(73) Assignee: aFIRE INC., Evanston, IL (US)

(21) Appl. No.: 12/699,021

(22) Filed: Feb. 2, 2010

(51) Int. Cl. A47J 37/07

(52) U.S. Cl. 126/25 B

(57) ABSTRACT

A stove, body of the present invention includes a stove body, a coal grid, an igniting grid and an incloser. The stove body has an annular shell which defines an upper opening and a lower opening. The coal grid is disposed in the stove body, and the igniting grid is detachably disposed at a center of the coal frame. The igniting grid has a protrusive arc grid surface and a cup disposed under the arc grid surface. The incloser detachably surrounds the igniting grid. Both end of the incloser are open ends. A fire-starting space is defined between the igniting grid and the incloser for solid fuel to dispose therein when the solid fuel is being lit. When the solid fuel is lit, the incloser is detached from the igniting grid, whereby the solid fuel rolls onto the coal grid along the arc grid surface automatically.

### BACKGROUND OF THE INVENTION

1. Field of the Invention

The present invention relates to a cooking stove, and more particularly to a cooking stove with convenient fire-starting mechanisms.

2. Description of the Prior Art

Barbecue is popular around the globe, especially in reunions or outings with family or friends. People can have fun broiling food manually and interacting with each other at the same time.

Some conventional cooking stoves, such as disclosed in Taiwanese Utility Model Patent No. 339631, are indirect-heating type stove—the heat source is not located right beneath the food, but they mainly cook the meat by convection air generated by the lateral heating source. However, such indirect-heating type cooking stove has trouble starting fire because the charcoal thereof is scattered.

### SUMMARY OF THE INVENTION

The main object of the present invention is to provide a cooking stove with convenient fire-starting mechanisms.

To achieve the above and other objects, a stove body of the present invention includes a stove body, a coal grid, an igniting grid and an incloser. The stove body has an annular shell which defines an upper opening and a lower opening. The coal grid is disposed in the stove body, and the igniting grid is detachably disposed at a center of the coal frame. The igniting grid has a protrusive arc grid surface and a cup disposed under the arc grid surface. The incloser detachably surrounds the igniting grid. Both end of the incloser are open ends. A fire-starting space is defined between the igniting grid and the incloser for solid fuel to dispose therein when the solid fuel is being lit.

When the solid fuel is lit, the incloser is detached from the igniting grid, whereby the solid fuel rolls onto the coal grid along the arc grid surface automatically. As such, the cooking stove of the present invention provides an indirect-heating source, and the solid fuel thereof is more easily lit.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing a cooking stove of the present invention;

FIG. 2 is a drawing showing a cooking stove, which is ready to start fire, of the present invention;

FIG. 3 is a profile showing a cooking stove, which is ready to start fire, of the present invention;

FIG. 4 is a profile showing a cooking stove, which is starting fire, of the present invention;

FIG. 5 is a profile showing a cooking stove, whose solid fuel is lit, of the present invention;

FIG. 6 is a profile showing a cooking stove, which is adapted for barbecue, of the present invention;

FIG. 7 is a perspective drawing showing a cooking stove, which is adapted for barbecue, of the present invention;

FIG. 8 is a perspective drawing showing a cooking stove, which is broiling food, of the present invention;

FIG. 9 is a breakdown drawing showing a cooking stove, which is adapted for chicken roasting, of the present invention;

FIG. 10 is a profile showing a cooking stove, which is roasting chickens, of the present invention;

FIG. 11 is a lateral view showing a food carrier of the present invention;

FIG. 12 is a perspective drawing showing a table installed with a cooking stove of the present invention.

### DETAILED DESCRIPTION OF THE PREFERRED EMBODIMENTS

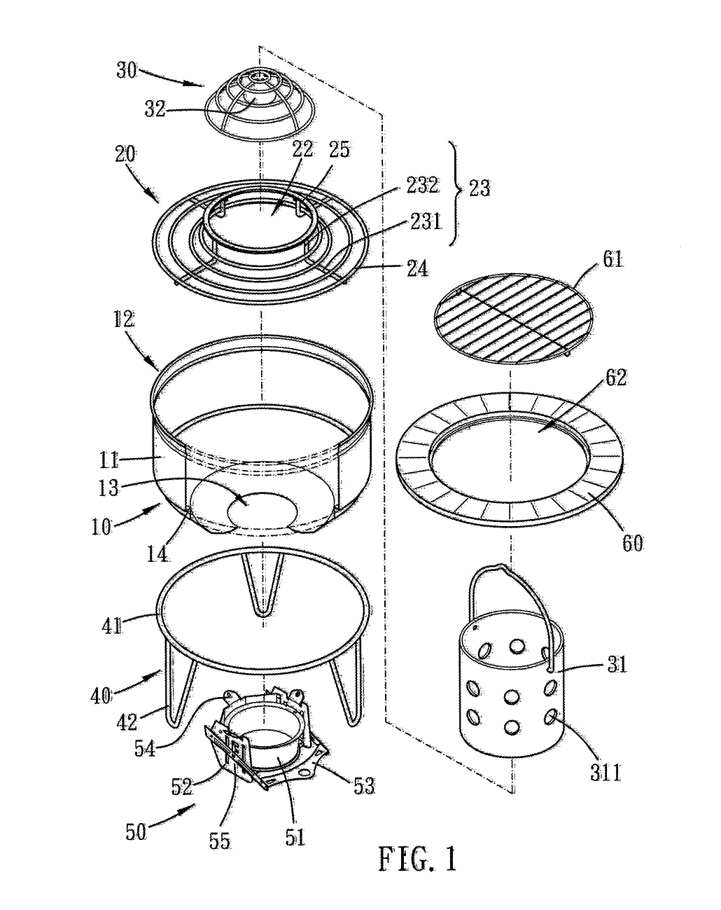

Please refer to FIG. 1. A cooking stove of the present invention includes a stove body 10, a coal grid 20, an igniting grid 30, an incloser 31, a base 40, a venting system 50, an annular cover plate 60 and a gridiron 61.

The stove body 10 has an annular shell 11 which defines an upper opening 12 and a lower opening 13. The lower opening 13 is smaller than the upper opening 12. The stove body 10 has a lower portion being tapered such that the air flow rate accelerates as the air enters the stove body 10 of bigger cross section via the lower opening 13 of smaller cross section. In addition, a negative pressure of the stove body 10 will draw the air into the stove body 10 to promote its air circulation.

The base 40 is adapted to support the stove body 10. Preferably, the base 40 has a displacement portion 41 corresponding to the contour of the stove body 10, and has several supportive portions 42. The stove body 10, on the other hand, has a stepped outer engaging section 14 to engage with the displacement portion 41.

Please further refer to FIG. 4. The venting system 50 includes a screen 51 and an elevation means. The screen 51 is preferably in a pot shape so as to collect ashes therein, and the screen 51 is dispose beneath the lower opening 13. The elevation means is used to adjust a height of the screen 51 so as to enable the screen 51 to selectively move close to or away from the lower opening 13. More specifically, the elevation means includes a main body 52 and an adjuster 53. The main body 52 has a fixation portion 54 and a connecting portion 55. The fixation portion 54 is fixed to a bottom of the stove body 10, and the adjuster 53 is movably connected to the connecting portion 55. The screen 51 and the adjuster 53 are in a motional operative relationship, so that the screen 51 may be movable by the adjuster 53 to selectively move close to or away from the lower opening 13. The connecting portion 55 is preferably provided with an F-shaped rail for the adjuster 53 to slide therealong and rest at different height. As such, the air flow of the lower opening 13 is controllable to further control the burning rate of the fuel in the stove body 10.

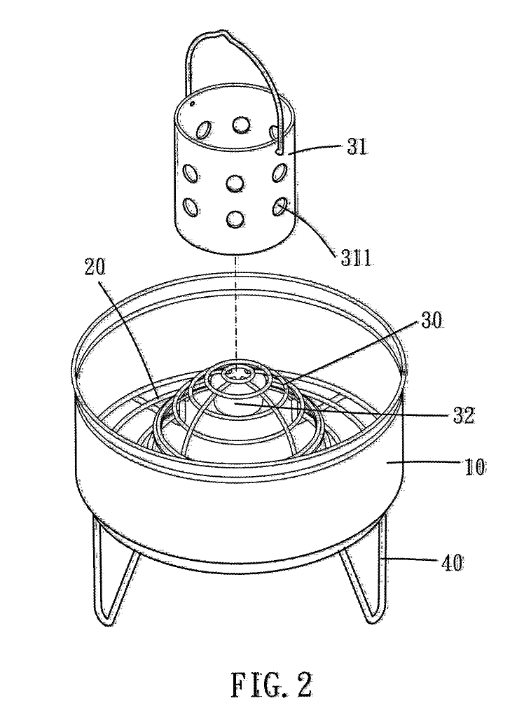

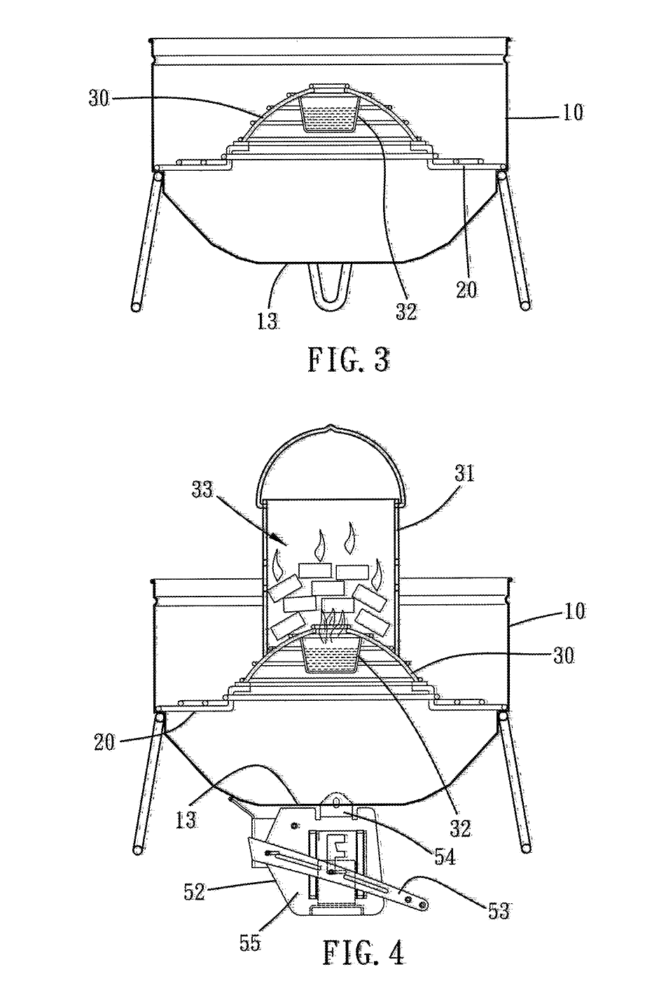

Please further refer to FIG. 2 and FIG. 3. The coal grid 20 is disposed in the stove body 10, and preferably on the engaging section 14. The coal grid 20 may have a grid opening 22 defined at its center, and it may further have several radial ribs 23, several annular ribs 24 and a supporting coil 25. The radial ribs 23 are radially disposed from the grid opening 22. Each of the radial ribs 23 has a horizontal section 231 and a vertical section 232 extending upward, and each radial rib 23 is substantially L-shaped. The vertical sections 232 of the radial ribs 23 are disposed around the grid opening 22. Each of the annular ribs 24 has a different diameter from the others and is disposed on the horizontal sections 231. The supporting coil 25 is supported by the vertical sections 232 and surrounds the grid opening 22. In such case, the supporting coil 25 is higher than the ribs 23 and 24. The igniting grid 30 is therefore detachably disposed on the supporting coil 25—the center of the coal grid 20. The igniting grid 30 has a protrusive arc grid surface and has a cup 32 disposed under the arc grid surface for liquid fuel such as alcohol gel or solid fuel such as tinder or other fire lighter to dispose therein.

The incloser 31 detachably surrounds the igniting grid 30, and a plurality of venting bores 311 are disposed around its periphery. Both end of the incloser 31 are open ends. As such, a fire-starting space 33 is defined between the igniting grid 30 and the incloser 31 for solid fuel, such as charcoal, to dispose therein when the solid fuel is being lit, as shown in FIG. 4.

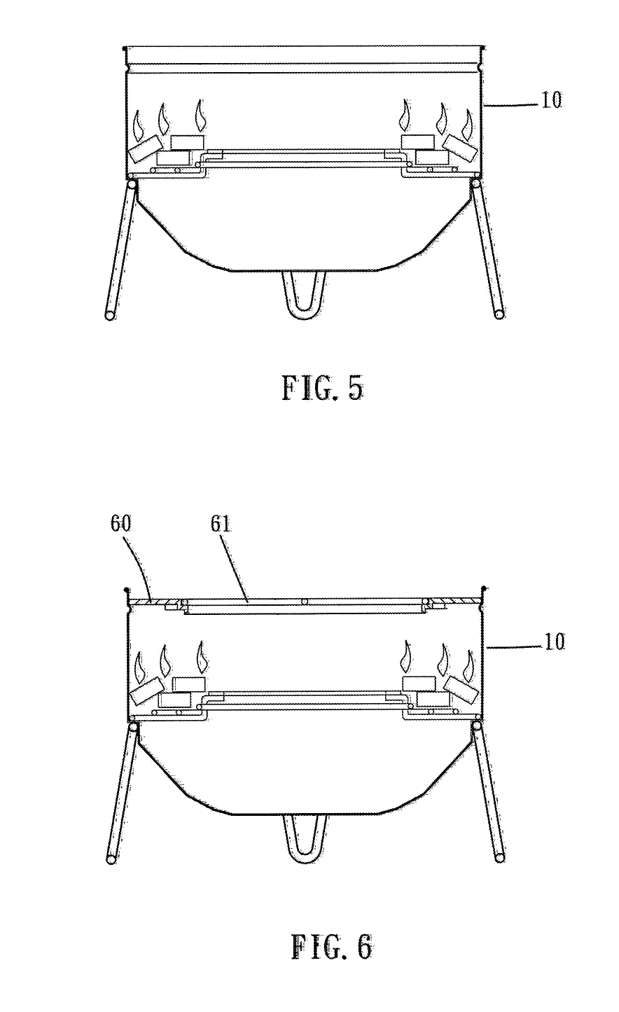

Please refer to FIG. 5. Once the charcoal is lit, the incloser 31 can be detached from the igniting grid 30. Thereby, the charcoal rolls onto the coal grid 20 along the arc grid surface and spreads around the grid opening 22. The igniting grid 30 is, thereafter, detached from the coal grid 20, finishing the fire-starting procedure.

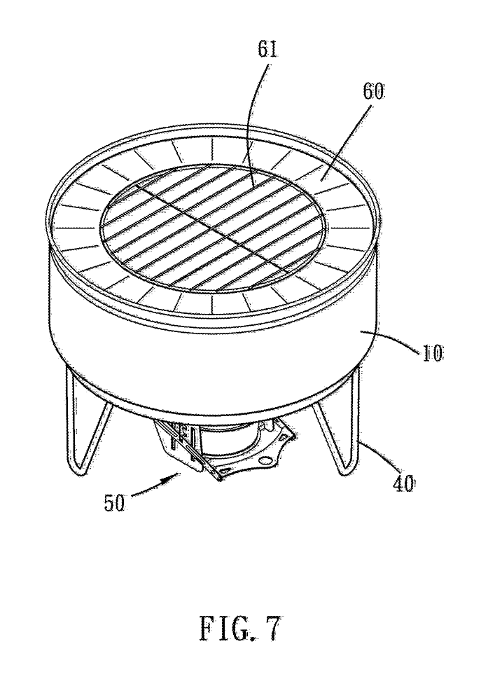

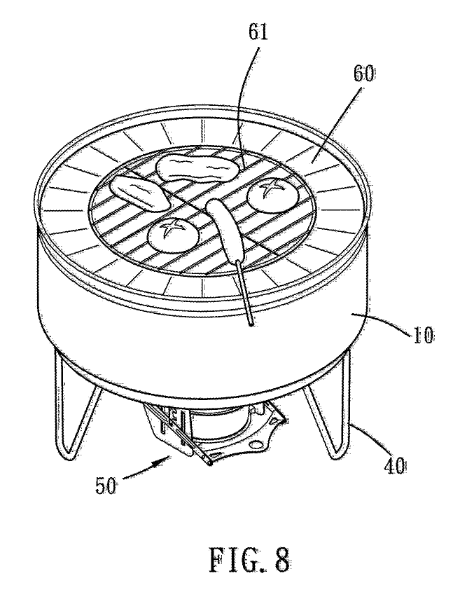

The annular cover plate 60 can be, thereafter, disposed on the upper opening 12 of the stove body 10, as shown in FIG. 6 and FIG. 7. The annular cover plate defines a plate opening 62 at its center, and the gridiron 61 is disposed on the plate opening 62. As such, the cooking stove of the present invention is ready for grilling food in an indirect-heating manner, as shown in FIG. 8.

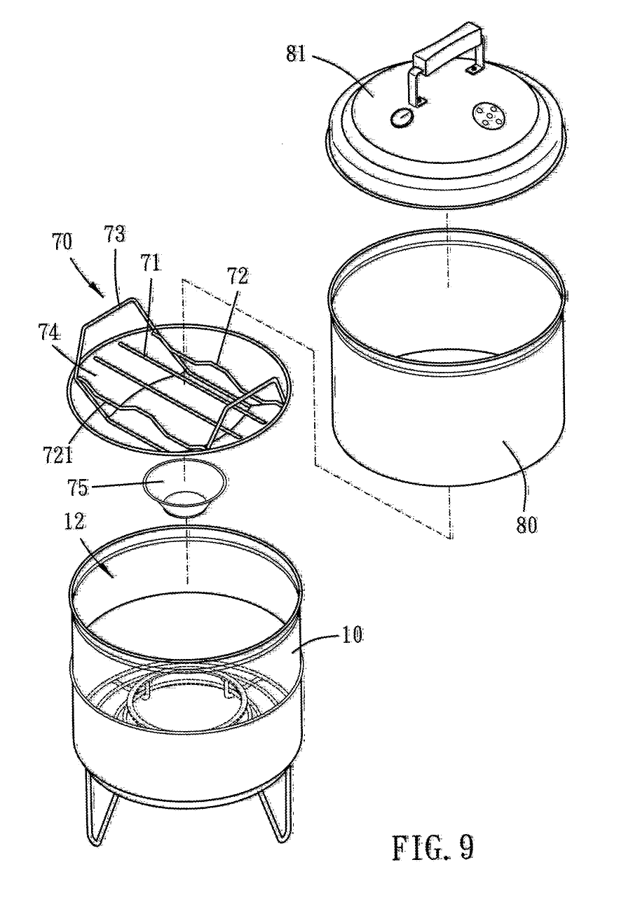

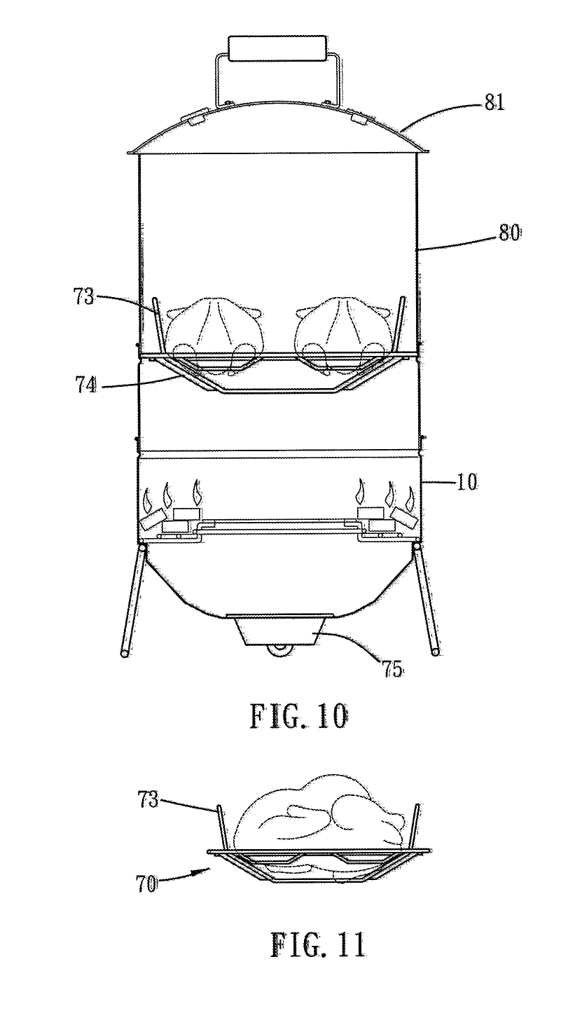

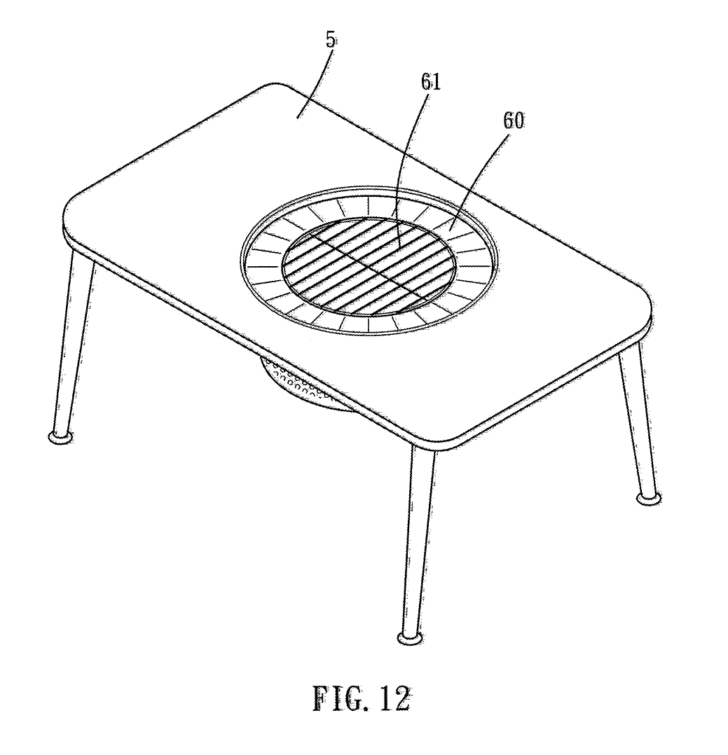

The cooking stove of the present invention is further adapted for chicken roasting. Thus the cooking stove is further provided with a food carrier 70, an annular extender 80 and a cover 81 for enveloping an upper opening of the extender 80, as shown in FIG. 9. The food carrier 70 is disposed on the upper opening 12 of the stove body 10, and has two parallel supporting rods 71 and two auxiliary rods 72 disposed beside the supporting rods 71. Each of the auxiliary rods 72 has two sunken sections 721 and is substantially W-shaped. As such, the food carrier 70 is adapted to transversely carry two chickens thereon, as shown in FIG. 10, or to longitudinally carry a larger turkey thereon, as shown in FIG. 11. The food carrier 70 may further has two opposite grip portions 73 for transportation purposes. A shallow basin 75 may be further provided to catch the chicken essence. And preferably, the food carrier 70 may be provided with two opposite wings 74 for the chicken essence to slide thereon in order to drop into the basin 75 rather than on the charcoal. In addition, the cooking stove of the present invention may be installed on a table 5, as shown in FIG. 12, for users to sit therearound and to have fun broiling food together.

What is claimed is:

1. A cooking stove, comprising:
a stove body, having an annular shell which defines an upper opening and a lower opening;
a coal grid, disposed in the stove body;
an igniting grid, detachably disposed at a center of the coal grid, the igniting grid having a protrusive arc grid surface, the igniting grid having a cup disposed under the arc grid surface;
an incloser, detachably surrounding the igniting grid, the incloser having an open upper end and an open lower end, a fire-starting space being defined between the igniting grid and the incloser for solid fuel to dispose therein when the solid fuel is being lit.

2. The cooking stove of claim 1, wherein when the solid fuel is lit, the incloser is detached from, the igniting grid, whereby the solid fuel rolls onto the coal grid along the arc grid surface.

3. The cooking stove of claim 2, wherein when the solid fuel has rolled onto the coal grid, the igniting grid is detached from the coal grid.

4. The cooking stove of claim 3, further comprising an annular cover plate and a gridiron, the annular cover plate being disposed on the upper opening of the stove body and defining a plate opening at its center, the gridiron being disposed on the plate opening.

5. The cooking stove of claim 1, further comprising a base for supporting the stove body.

6. The cooking stove of claim 5, further comprising a screen disposed beneath the lower opening of the stove body; and an elevation means for adjusting a height of the screen so as to enable the screen to selectively move close to or away from the lower opening.

7. The cooking stove of claim 3, further comprising a food carrier disposed on the upper opening of the stove body, the food carrier having two parallel supporting rods and two auxiliary rods disposed beside the supporting rods, each of the auxiliary rods having two sunken sections and being substantially W-shaped.

8. The cooking stove of claim 7, wherein the food carrier further has two opposite grip portions.

9. The cooking stove of claim 7, further comprising an annular extender and a cover for enveloping the annular extender, the annular extender is disposed on the upper opening.

10. The cooking stove of claim 1, wherein the coal grid has a grid opening defined at its center, the coal grid further has several radial ribs, several annular ribs and a supporting coil, the radial ribs are radially disposed from the grid opening, each of the radial ribs has a horizontal section and a vertical section extending upward and each radial rib is substantially L-shaped, the vertical sections of the radial ribs are disposed around the grid opening, each of the annular ribs has a different diameter from the others and is disposed on the horizontal sections, the supporting coil is supported by the vertical sections and surrounds the grid opening, the igniting grid is disposed on the supporting coil.
